(19) United States
(12) Patent Application Publication
(10) Pub. No.: US 2020/0267274 A1
(43) Pub. Date: Aug. 20, 2020

(54) IMAGE FORMING APPARATUS AND IMAGE FORMING SYSTEM

(71) Applicant: KONICA MINOLTA, INC., Tokyo (JP)

(72) Inventor: Tatsuyoshi HAGA, Tokyo (JP)

(73) Assignee: KONICA MINOLTA, INC., Tokyo (JP)

(21) Appl. No.: 16/741,928

(22) Filed: Jan. 14, 2020

(30) Foreign Application Priority Data
Feb. 19, 2019 (JP) 2019-027264

(51) Int. Cl. H04N 1/00; G06F 3/12

(52) U.S. Cl. CPC H04N 1/00676; G06F 3/1204; H04N 2201/0094; G06F 3/1231; H04N 1/00464; G06F 3/1205

(57) ABSTRACT

A hardware processor of an image forming apparatus makes settings for an image forming process performed on a sheet, in accordance with an instruction from a user to a first user interface section, and makes settings for postprocessing performed on the sheet, on the basis of an instruction from the user to a second user interface section that is different from the first user interface section, and the settings for the image forming process and the settings for the postprocessing are made in association with each other.

### CROSS REFERENCE TO RELATED APPLICATIONS

The entire disclosure of Japanese Patent Application No. 2019-027264 filed on Feb. 19, 2019 is incorporated herein by reference in its entirety.

### BACKGROUND

### Technological Field

The present invention relates to an image forming apparatus and an image forming system.

### Description of Related Art

There has been the image forming system that has an image forming apparatus and a postprocessing apparatus which are series-connected. In this image forming system, sheets (a printed material) output from the image forming apparatus (see Japanese Patent Application Laid-Open No. 2002-232619, for example) can undergo postprocessing in the postprocessing apparatus, producing the output material that the user desires. Examples of postprocessing in the postprocessing apparatus include folding processing (such as center-folding and tri-folding), punching processing, and binding processing on a printed material. An appropriate combination of these postprocessing yields booklets, case bookbinding, and other output materials.

Recent postprocessing apparatuses are provided with a postprocessing apparatus called a trimmer unit (cutter machine) and thus capable of giving output materials of a desired size, such as business cards, tickets, and coupons, or performing various types of processing, such as folding or perforating, on the output materials.

By the way, when the postprocessing apparatus described above is used, various types of processing can be performed after formation of an image, and more items of postprocessing settings are thus required before formation of the image; therefore, the problem arises that making postprocessing settings from scratch for each printing job makes the operation time-consuming. Accordingly, when a postprocessing apparatus is used, it is conceivable that multiple postprocessing settings are pre-registered as postprocessing profiles and designation (selection) is made from the postprocessing profiles during print setting, thereby adding (imbedding) postprocessing settings during print setting.

However, with the conventional technique, settings for postprocessing with many items to set should be made through the operation panel or the like on the image forming apparatus, so that the problem arises that other users who want to use, for example, the copy function cannot make operations simultaneously, which leads to poor printing productivity and workability. With the format (data format) in which postprocessing settings are included in the print settings as in the conventional technique, for example, the problem arises that, when fine adjustment of a specific cutting position is applied to the entire printed material (multiple sheets), all the related print settings must be changed, extending work or processing time.

### SUMMARY

An object of the present invention is to provide an image forming apparatus and an image forming system capable of concurrently making settings for an image forming process and settings for postprocessing.

To achieve at least one of the abovementioned objects, according to an aspect of the present invention, an image forming apparatus reflecting one aspect of the present invention comprises:

a hardware processor that makes settings for an image forming process performed on a sheet, in accordance with an instruction from a user to a first user interface, wherein

the hardware processor makes settings for postprocessing performed on the sheet, on a basis of an instruction from the user to a second user interface that is different from the first user interface, and

the settings for the image forming process and the settings for the postprocessing are made in association with each other.

To achieve at least one of the abovementioned objects, according to another aspect of the present invention, an image forming system reflecting one aspect of the present invention comprises:

the image forming apparatus described above; and

a postprocessing apparatus connected on a downstream side of the image forming apparatus.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram of an image forming system of this embodiment;

FIG. 2 is a functional block diagram of the control system for the image forming system; and

FIG. 3 is a flowchart for explaining a process executed by a control section of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

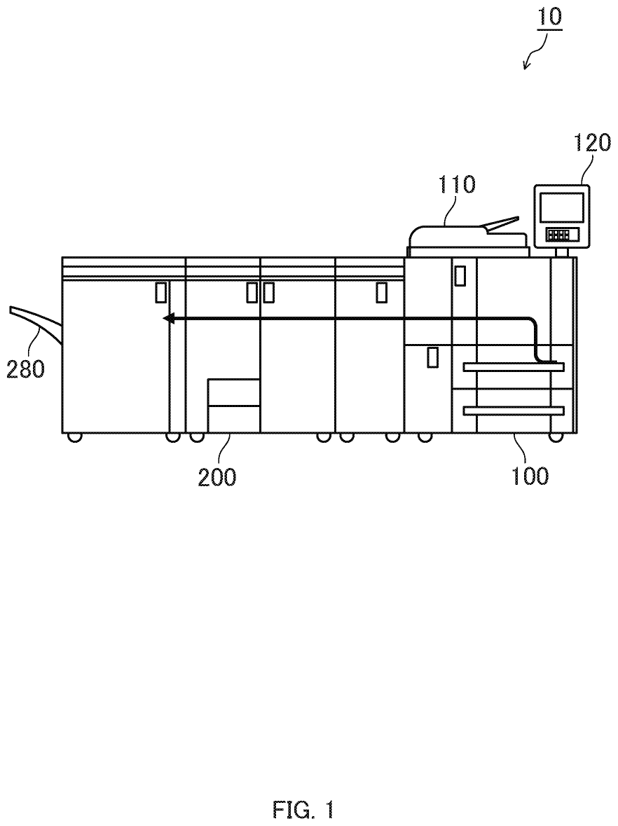

The image forming system according to this embodiment will be described in detail with reference to the accompanying drawings. FIG. 1 shows the overall configuration of image forming system 10 of this embodiment. In image forming system 10, image forming apparatus 100 as a multi function peripheral (MFP) is connected to postprocessing apparatus 200 that performs various types of postprocessing, such as cutting, on a sheet (output material) with an image formed by image forming apparatus 100. The arrow in the drawing schematically shows the sheet conveyance path, and the sheet printed by image forming apparatus 100 is subjected to predetermined postprocessing by postprocessing apparatus 200 connected on a downstream side of image forming apparatus 100, and then is discharged onto sheet tray 280.

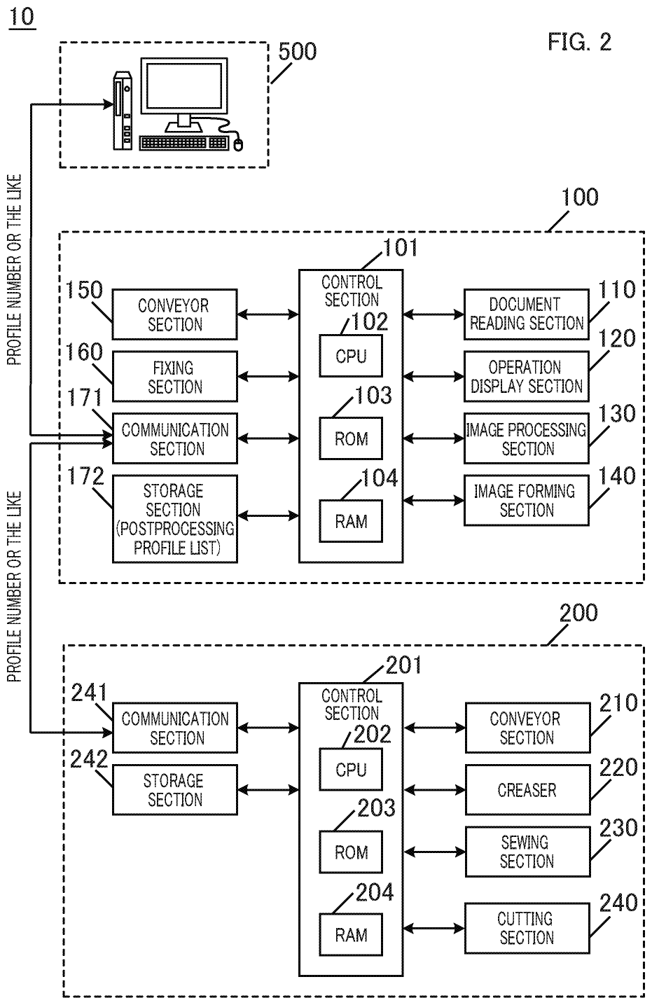

Next, the configuration of the control system for image forming system 10 will be described with reference to FIG. 2. Image forming system 10 includes image forming apparatus 100, postprocessing apparatus 200, and external apparatus 500, such as a personal computer (PC) or a mobile terminal.

Of these, external apparatus 500 serves as a first user interface section that displays a setting screen (not shown) on the display section and enters (instructs to enter) various items related to printing (image forming process) prior to execution of a printing job (print job) when image forming apparatus 100 is made to function as a printer. Here, examples of the setting items related to formation of an image include the number of sheets to be printed (number of pages), the margin area of sheets, single-sided printing/double-sided printing, the number of copies, sheet size, color printing/monochrome printing, and various other items related to image forming processing.

In addition, external apparatus 500 serves as a job submitting interface that transmits (submits) an input image and print setting data of the setting items described above to image forming apparatus 100 when executing a print job when image forming apparatus 100 is made to function as a printer. The term “interface” will be hereinafter abbreviated as “IF”.

Moreover, when postprocessing apparatus 200 executes postprocessing on a sheet with an image formed, external apparatus 500 serves as a second user interface section that displays a setting screen (not shown) on the display section and enters (instructs to enter) various items related to postprocessing prior to execution of the postprocessing.

Here, different interfaces are used or implemented for the first user interface section and the second user interface section. A specific example of the first user interface section is a printer driver application (software) for image forming apparatus 100. The details of the second user interface section will be described later.

Image forming apparatus 100 includes control section 101, document reading section 110, operation display section 120, image processing section 130, image forming section 140, conveyor section 150, fixing section 160, communication section 171, and storage section 172.

Control section 101 includes central processing unit (CPU) 102, read only memory (ROM) 103, and random access memory (RAM) 104. CPU 102 reads a program, which is appropriate for the processing content, from ROM 103 and expands it in RAM 104, and controls the operation of each block of image forming apparatus 100 in cooperation with the expanded program. At this time, various types of data stored in storage section 172 are referred to. Storage section 172 consists of, for example, a nonvolatile semiconductor memory (so-called flash memory) or a hard disk drive.

In this embodiment, CPU 102 and RAM 104 of control section 101 in image forming apparatus 100 function as an “image forming process setting section” and an “association setting section” of the present invention. Control section 101 and storage section 172 correspond to a “postprocessing setting unit” of the present invention.

Of these, the “image forming process setting section” executes, before the execution of a printing job, a process in which the data of the printing job containing the acquired image data and various types of setting information (for example, the size and orientation of the sheet, double-sided printing or color printing option, and the setting of a margin area) is stored in RAM 104 through a user IF (first user interface section which will be hereinafter also referred to as “job submitting IF”) on which a print setting screen is displayed.

The “image forming process setting section” executes a process of registering the data of the printing job that needs to be saved, to storage section 172. The data of the printing job (image data and setting data) registered to storage section 172 is stored in RAM 104 as a copier job upon the next printing later.

Note that the job submitting IF setting screen is normally displayed on external apparatus 500 when the printing job is a print job, and is displayed on operation display section 120 of image forming apparatus 100 when the printing job is a copier job. For this reason, when a copier job is executed, control section 101 and operation display section 120 of image forming apparatus 100 serve as a first user interface section.

The “association setting section” will be described later.

Control section 101 transmits and receives various types of data to and from external apparatus 500 (such as a PC or a mobile terminal) connected to a communication network such as a local area network (LAN) or a wide area network (WAN), via communication section 171. For example, control section 101 receives image data transmitted from an external apparatus, and forms an image on a sheet based on this image data (input image data). Communication section 171 consists of a communication control card, such as a LAN card, for example.

Document reading section 110 optically scans a document conveyed on contact glass, forms an image of reflected light from the document, on the light receiving surface of a charge coupled device (CCD) sensor, reads the document, and outputs the image of the read document as an analog image signal. Note that the document is conveyed onto contact glass by an automatic document feeder (ADF); alternatively, the document may be manually placed on contact glass.

This operation display section 120 consists of, for example, a liquid crystal display (LCD) with a touch screen, and functions as a display section and an operation section. The display section displays various operating screens, the image state, the operation status of each function, and the like in response to a display control signal input from control section 101. The operation section, which includes various operation keys, such as a numeric key pad and a start key, receives various input operations from the user and outputs an operation signal to control section 101.

Image processing section 130 includes a circuit that performs analog-digital (A/D) conversion processing and a circuit that performs digital image processing. Image processing section 130 generates digital image data by A/D conversion processing from the analog image signal acquired by the CCD sensor of document reading section 110 and outputs the digital image data to image forming section 140. Further, image processing section 130 performs tone correction based on the tone correction data (tone correction table LUT) in storage section 172 under the control by control section 101. Further, image processing section 130 performs various correction processes other than tone correction, such as color correction and shading correction, a compression process, and the like on the input image data. Image forming section 140 is controlled based on the image data that has been subjected to these processes.

Image forming section 140 emits laser light based on the digital image data generated by image processing section 130, and irradiates the photoconductor drum with the emitted laser light, forming an electrostatic latent image on the photoconductor drum (light exposure step).

Image forming section 140 is configured to execute, in addition to the aforementioned light exposure step, a charging step performed before the light exposure step, a development step performed after the light exposure step, a transfer step after the development step, and a cleaning step performed after the transfer step.

In the charging process, image forming section 140 uniformly charges the surface of the photoconductor drum by corona discharging from the charging device. In the development step, image forming section 140 forms a toner image on the photoconductor drum by making the toner contained in the developer in the developing device adhere to the electrostatic latent image on the photoconductor drum.

In the transfer process, image forming section 140 transfers the toner image on the photoconductor drum onto the sheet conveyed by conveyor section 150. In the cleaning step, image forming section 140 removes the toner remaining on the photoconductor drum after the transfer step.

Fixing section 160 fixes the toner image on the sheet by applying heat and pressure (heating fixation) to the toner image on the sheet introduced into the fixing nip section (fixing step). As a result, a fixed toner image is formed on the sheet. Thus, through the aforementioned steps carried out in image forming apparatus 100, a toner image based on an image read by document reading section 110 or image data received from external apparatus 500 is formed (transferred) and fixed on a sheet. The sheet on which the toner image is fixed is supplied to postprocessing apparatus 200 located in the subsequent stage (on the downstream side) (see FIG. 1).

In image forming system 10, postprocessing apparatus 200 includes control section 201, conveyor section 210, creaser 220, sewing section 230, cutting section 240, communication section 241, and storage section 242.

Control section 201 includes central processing unit (CPU) 202, read only memory (ROM) 203, and random access memory (RAM) 204. CPU 202 reads a program appropriate for the processing content from ROM 203 and expands it in RAM 204, and controls the operation of each block of postprocessing apparatus 200 in cooperation with the expanded program. At this time, various types of data stored in storage section 242 are referred to. Storage section 242 consists of, for example, a nonvolatile semiconductor memory (so-called flash memory) or a hard disk drive.

Conveyor section 210 includes a sheet conveyance path and conveyance rollers, and has the function of supplying, under the control by control section 201, a sheet with an image formed by image forming apparatus 100, to later-described creaser 220, sewing section 230, cutting section 240, and sheet tray 280 (see FIG. 1).

Creaser 220 includes a crease blade that forms a crease (fold line) on a sheet and a drive source that drives the crease blade, and forms a fold line in a preset position of the sheet under the control by control section 201.

Sewing section 230 includes a sewing blade that forms a perforation (cut line) on a sheet and a drive source that drives the sewing blade, and forms a cut line in a preset position of the sheet under the control by control section 201.

Cutting section 240 includes various cutters (cutting blades) for cutting sheets and a drive source that drives each cutter. To be specific, cutting section 240 includes a cutter and a drive source for “four-side cutting” and a cutter and a drive source for “multi-cutting”, which will be described later, and drives the appropriate drive source under the control by control section 201, thereby performing various cuttings on the sheet printed with an image. Usually, when image forming apparatus 100 prints various types of sheets, margins are generated on the four sides of the sheet (that is, around the fixed toner image); therefore, basically, a cutter and a drive source for “four-side cutting” are most often used for cutting section 240.

Next, the types and the like of postprocessing executed by postprocessing apparatus 200 will be described. In the case where various types of postprocessing described in the following columns (A) to (E) are performed, before performing them, settings are entered (instructed) for various items related to the image forming process (printing on the sheet) through the setting screen of the job submitting IF (first user interface section) described above.

(A) Four-Side Cutting Only

For example, in printing a flyer or the like, margin areas on four sides other than the print area on the sheet are often cut off. In this case, while settings for the postprocessing for postprocessing apparatus 200 are made, the four-side cutting is selected so that the aforementioned cutter for four-side cutting in cutting section 240 is driven.

(B) Combined Use of Multi-Cutting

In the case where relatively small printed materials, such as flyers and banners, are output, two printed materials can be output on one sheet (for example, in the case where banner printing is performed for two sheets of A3 paper). In the case where further smaller printed materials, such as business cards and other cards, are output, further more printed materials can be output on one sheet (for example, in the case where (2×5=10) business cards are fabricated from one thick paper). In this case, while settings for the postprocessing for postprocessing apparatus 200 are made, a cutting mode in which both the cutter for four-side cutting and the cutter for multi-cutting in cutting section 240 are used is selected.

(C) Combined Use of Creaser

In the case where a catalog, a pamphlet or the like is output, creaser 220 can be used in combination with the aforementioned four-side cutting in order to add a fold line to the sheet. In this case, while settings for the postprocessing for postprocessing apparatus 200 are made, a mode in which the cutter for four-side cutting by cutting section 240 is driven and a fold line is made by creaser 220 is selected.

(D) Combined Use of Multi-Cutting and Sewing

In the case where a ticket, a coupon or the like is output, sewing section 230 can be used in combination with the aforementioned four-side cutting in order to cut out a part of the sheet. In this case, while settings for the postprocessing for postprocessing apparatus 200 are made, a mode in which the cutter for four-side cutting by cutting section 240 is driven and sewing by sewing section 230 is performed is selected.

(E) Other

Although not shown, for other postprocessing functions of postprocessing apparatus 200, various postprocessing functions, such as a stapler that binds sheets at an end, a punching section that forms punch holes on one end of sheets, and a folding section that folds sheets, can be added.

(Adjustment and the Like During Operational Phase)

Next, description will be made regarding work in a preparation stage such as installation of image forming apparatus 100 and postprocessing apparatus 200 in image forming system 10. The following work is performed exclusively by a serviceman.

Preparation 1: Align

First, the reference position of postprocessing apparatus 200 is aligned with the sheet outlet of image forming apparatus 100, so that variations, wrinkles, and the like depending on each machine are corrected.

Preparation 2: Create Postprocessing Profile

For preparation, a template for the cutting position or crease or perforation position is made by creating a profile for postprocessing executed by postprocessing apparatus 200.

The following work in “Preparation 3” and “Preparation 4” is performed independently for each printing job.

Preparation 3: Set Postprocessing Content and Position on Sheet

In the stage of setting for printing job, the content of postprocessing performed on the sheet (for example, cutting) and the position on the sheet are designated.

Preparation 4: Finely Adjust Positions of Components of Postprocessing Apparatus 200

In the stage of confirming print proof, the printing job executed by image forming apparatus 100 and the postprocessing executed by postprocessing apparatus 200 are experimentally executed, and the positions of the components of creaser 220, sewing section 230, and cutting section 240 of postprocessing apparatus 200 are finely adjusted according to the quality of the resulting output material (test material). This fine adjustment corrects errors in paper size caused by a difference in sheet lot, ambient temperature and humidity, coverage, and the like.

Thus, after the pre-adjustment and other work described in Preparations 1 to 4, printing and postprocessing as an actual job are executed by image forming apparatus 100 and postprocessing apparatus 200.

Incidentally, as described above, in image forming system 10 that performs, through postprocessing apparatus 200, various types of postprocessing on the sheet with an image printed by image forming apparatus 100, various types of postprocessing can be performed, so that more items should be set in advance in the stage of “Preparation 3”.

In the conventional system, to perform postprocessing described above on the printed sheet, settings for postprocessing are made, for example, on the property screen of “Print Option” as a setting item of a printing job in the stage of making settings for the printing job (first user interface section). In other words, in the conventional image forming system, the set contents for postprocessing are included in the setting items for the printing job.

However, with the conventional technique, settings for postprocessing with many items to set should be made through operation display section 120 of image forming apparatus 100, so that the problem arises that other users who want to use, for example, only the copy function on image forming apparatus 100 cannot make operations simultaneously, which leads to poor printing productivity and workability.

Besides, with the conventional technique, postprocessing settings are incorporated into print settings. Therefore, if postprocessing settings such as cutting with many setting items described above are added during the print settings, the problem arises that the print setting profile (data amount) is enlarged. In addition, with the format (data format) in which postprocessing settings are included in the print settings as in the conventional technique, for example, the problem arises that, when fine adjustment of a specific cutting position is applied to the entire printed material (multiple sheets), all the related print settings must be changed, extending work or processing time.

Further, in recent years, use of not only image forming apparatus 100 (body side) but also a job definition format (JDF), workflow application, mobile print, and the like allows print settings to be managed through not only PCs but various external apparatuses 500 such as compact mobile terminals. For this reason, with the format in which the postprocessing settings are included in the print settings, the problem arises that making complicated postprocessing settings on external apparatus 500 complicates the print settings. There has been another problem in that postprocessing settings cannot be shared among multiple external apparatuses 500 due to the difference in installed applications, interfaces, and the like between external apparatuses 500.

To solve various problems described above, in image forming system 10 according to this embodiment, the procedure and data of the setting profile for postprocessing performed in postprocessing apparatus 200 are separated from those of the setting profile for a printing job of image forming apparatus 100. In other words, in image forming system 10 according to this embodiment, it is prohibited to make settings related to the postprocessing performed by postprocessing apparatus 200 on the printing job setting screen on image forming apparatus 100.

In particular, in the conventional system, to perform postprocessing on a printed sheet, settings for postprocessing are made as a setting item of a printing job (for example, on the property screen of “Print Option”) in the stage of making settings for the printing job. In contrast, in this embodiment, upon setting for a printing job, setting for all postprocessing that can be executed by postprocessing apparatus 200 described above is prohibited. In other words, in this embodiment, it is prohibited to include a postprocessing job that can be executed by postprocessing apparatus 200 in the setting items for a printing job. With such a configuration in which the printing job and the postprocessing job are separated, complication of management can be prevented when print settings are made using various types of external apparatuses 500 and workflow applications.

Since postprocessing settings are made independent of printing jobs as described above, the contents of postprocessing such as cutting settings can be easily changed without changing the settings for printing job, and job settings for image forming apparatus 100 and job settings for postprocessing apparatus 200 can be made concurrently.

For this reason, with image forming system 10 of this embodiment, for example, a user who wants to execute printing and postprocessing and another user who wants to use only the copy function without performing postprocessing can concurrently make settings for each job, which enhances printing productivity and workability.

Further, in image forming system 10 of this embodiment, the setting profile for postprocessing separated from the setting profile for a printing job as described above is set in association therewith prior to the execution of printing (image forming process) and postprocessing. In this embodiment, control section 101 of image forming apparatus 100 serves as an “association setting section” that makes settings for an image forming process to be executed in the apparatus and settings for postprocessing to be executed in postprocessing apparatus 200, in association with each other.

With image forming system 10 according to this embodiment, the content (setting profile) of postprocessing performed in postprocessing apparatus 200 can be selected in advance as a template, and the contents of the template can be combined as appropriate to be a single job (hereinafter referred to as “postprocessing job”). Further, in this embodiment, an identification number (for example, a serial number) is assigned to each postprocessing job, and data (a postprocessing profile list) in which postprocessing jobs including these identification numbers are listed is registered.

With this configuration, postprocessing jobs can be easily edited or generated, and the contents of postprocessing can be specified by numbers in the stage of making settings for printing. Hence, a postprocessing job can be designated with a simple operation. Therefore, in this embodiment, it is possible to easily manage complicated settings for the postprocessing apparatus, for example, to combine various settings for a printing job and a postprocessing job.

The configuration related to settings for printing jobs and postprocessing jobs of image forming system 10 in this embodiment will now be described more specifically.

In this embodiment, a processing content (postprocessing job) profile (hereinafter referred to as “postprocessing profile”) such as cutting performed by postprocessing apparatus 200 is managed independently of settings for a printing job (they are roughly separated to print jobs and copier jobs). In other words, postprocessing profile data and its management (creation, edition, viewing, and the like of postprocessing jobs) are managed in a format physically separated from the printing job setting data (for example, in a separate data format).

In this embodiment, the main component that finally manages the postprocessing profile is on the body side, that is, control section 101 of image forming apparatus 100. For this reason, the postprocessing profile is stored in a list in a memory (in this example, storage section 172) in image forming apparatus 100 (see FIG. 2).

Alternatively, the main component that finally manages and stores the postprocessing profile may be in postprocessing apparatus 200 or external apparatus 500. Note that, in order to integrally process printing jobs and postprocessing jobs, the main component that manages and stores the postprocessing profile is preferably in image forming apparatus 100.

Thus, in this embodiment, control section 101 of image forming apparatus 100 functions as not only the above-described print settings registering section but also the following “postprocessing list generating section”, “association setting section”, and “postprocessing instructing section”.

Of these, the “postprocessing list generating section” corresponds to a part of the function of the “postprocessing setting section” of the present invention. The “postprocessing list generating section” executes a process in which a postprocessing profile list, which is the list of the contents of postprocessing (postprocessing jobs) executed by postprocessing apparatus 200 that have been preset through the setting screen of a user IF (the second user interface section) different from the aforementioned job submitting IF, is registered to storage section 172.

Here, the setting screen of the second user interface section may be displayed on either the display of external apparatus 500 such as a PC or a mobile terminal, or operation display section 120 of image forming apparatus 100. Thus, in this embodiment, the contents of the postprocessing executed by postprocessing apparatus 200 can be independently set and registered (stocked) in advance independently of print settings.

In this embodiment, management of postprocessing profile lists (for example, creation, edition, viewing, and deletion) as preparation is performed through an hypertext markup language (HTML) browser (web browser) of image forming apparatus 100. Use of such a web browser as the second user interface section allows postprocessing profiles (list) to be performed by various external apparatuses 500 installed with browsers (for example, servers on a network, PCs, and mobile terminals). The setting screen can be shared among the terminals.

Further, this embodiment enables postprocessing profiles (list) to be managed without a restriction on a work space or the like, and can be used in any step of submission, imposition, and printing. In this embodiment, the postprocessing profile list to be managed is stored in a storage medium (in this example, storage section 172) in image forming apparatus 100, so that postprocessing settings can be centrally managed.

The postprocessing profile list (for example, data structure) in one example is a list in which profile numbers as identification numbers for identifying a postprocessing job, profile names, and sheet information (for example, sheet size and basis weight) are listed in association with each other.

In the postprocessing profile list in the example, the profile numbers 001 to 005 have a profile name “four-side cutting only” (refer to the aforementioned column (A)), and different sheet sizes are applied to different profile numbers. The profile numbers 006 to 015 have a profile name of “four-side cutting+multi-cutting” (refer to the aforementioned column (B)), and different sheet sizes and numbers of division are applied to different profile numbers. The profile numbers 016 to 025 have a profile name of “four-side cutting+creasing” (refer to the aforementioned column (C)), and different sheet sizes and positions of fold lines to be added on the sheet are applied to different profile numbers. The profile numbers 026 to 035 have a profile name of “four-side cutting+sewing” (refer to the aforementioned column (D)), and different sheet sizes and positions to be sewed on the sheet are applied to different profile numbers.

In addition, as the function of the “association setting section”, control section 101 performs a process in which, for each printing job, settings for a postprocessing job designated or selected by the user in accordance with the printing job are made in association with the settings for the printing job (the settings for the image forming process) (in this example, stored or temporarily saved in RAM 104).

Further, as the function of the “postprocessing instructing section”, for each printing job, control section 101 performs a process of instructing postprocessing apparatus 200 to make settings for a postprocessing job to be applied in accordance with the printing job, according to the selection by the user. Here, the “postprocessing instructing section” corresponds to a part of the function of the “postprocessing setting section” of the present invention.

In one specific example, control section 101 of image forming apparatus 100 displays a postprocessing profile list on the job submitting IF (first user interface section) upon setting for a printing job. When a postprocessing job in the processing profile list is selected by the user, postprocessing apparatus 200 is instructed to follow the contents of the selected postprocessing job. In the above example, the user only enters the profile number (in the above example, any one of 001 to 035) from the postprocessing profile list displayed on the screen of the job submitting IF (first user interface section), such as a print job, copier job, or workflow application, thereby designating a postprocessing profile. In this embodiment, the displayed postprocessing profile list cannot be edited (changed, deleted, added, or the like) on the setting screen of the job submitting IF (first user interface section).

Thus, in this embodiment, when a sheet is subjected to postprocessing, a print setting screen is displayed through the first user interface section, and a postprocessing profile list is displayed so that a profile number can be selected. The postprocessing profile list may be displayed in any timing.

As described above, if the postprocessing setting function is provided in the user IF (first user interface section) at the time of job submission, the number of combinations of printing jobs and postprocessing jobs becomes enormous, making it difficult to make settings for each job and sort them. If the postprocessing setting function is provided only in the first user interface section, the problem may arise that data processing gets complicated and requires long time and hardware resources are occupied.

Therefore, in this embodiment, a setting screen produced by a web user IF intended for generation of the postprocessing profile is displayed on the display section of image forming apparatus 100 or external apparatus 500, and the user enters values related to the postprocessing on the setting screen of the web user IF. This setting screen of the web user IF (web browser) corresponds to the “second user interface section” of the present invention.

Here, values related to postprocessing entered on the setting screen of the web user IF include sheet size (width/length) at the time of finishing, the position on the sheet of postprocessing (cutting, fold line, perforation or the like) performed on the sheet, and the number of sheets to be divided (imposed) from one sheet (horizontal direction/vertical direction).

In summary, the first user interface section and the second user interface section described above display setting screens showing different setting items.

With such a configuration, job submission print setting and postprocessing profile generation can be separated using different IFs so that they are concurrently subjected to work or processed. Further, since a postprocessing profile is generated through the web user IF, operation can be performed regardless of the type of terminal as long as a web browser is installed, so that a unified user IF can be used. For this reason, according to this embodiment, the postprocessing profile can be created not only in operation display section 120 (the operation section on the body side) of image forming apparatus 100, but also in external apparatus 500 (such as a PC or a mobile terminal) offline while image forming apparatus 100 is turned off.

In one specific example, when a copy job is submitted, postprocessing (cutting position) is designated through operation display section 120 of image forming apparatus 100. In this case, operation display section 120 of image forming apparatus 100 functions as the first user interface section (job submitting IF) and the second user interface section (web user IF). In this case, external apparatus 500, such as a PC or a mobile terminal, can also simultaneously function as the second IF, thereby adding a postprocessing profile list, for example.

Meanwhile, when a printing job is submitted through a workflow application (JDF command), postprocessing (cutting position) is designated through the workflow application (JDF command). When a printing job is created with a printer driver installed on a PC as external apparatus 500, postprocessing (cutting position) is designated through the printer driver. In this case, the display section and the operation section of external apparatus 500 such as a PC or a mobile terminal function as a first user interface section and a second user interface section.

Thus, according to this embodiment, it is possible to solve the conventional problem that it is difficult to create a user IF with unity in an environment where the job submission user IF is restricted depending on each user IF. Moreover, according to this embodiment, complicated settings related to the postprocessing of postprocessing apparatus 200 can be managed easily.

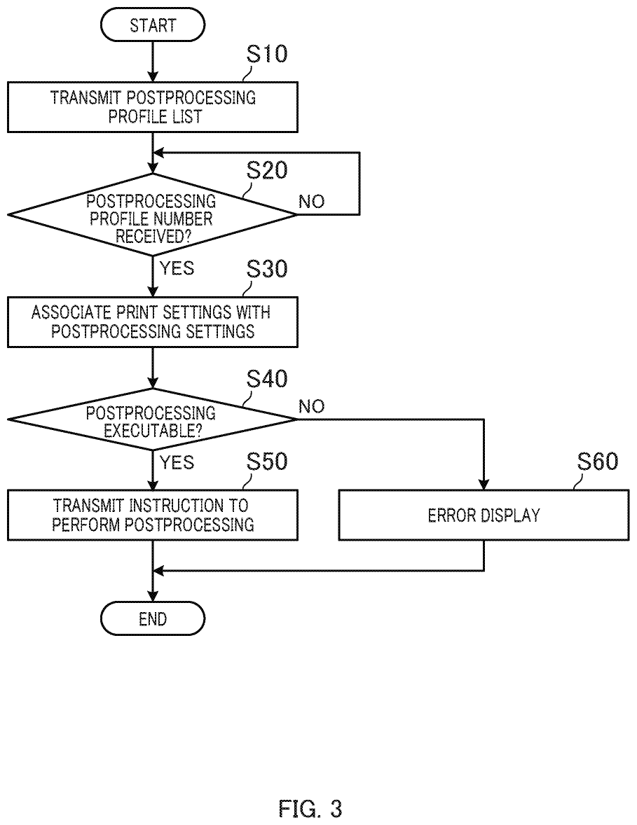

The control operation according to this embodiment will be described below with reference to the flowchart shown in FIG. 3. Note that the flowchart shown in FIG. 3 is executed after completion of “Preparation 1” and “Preparation 2” described above and “Preparation 3” is about to be performed. FIG. 3 shows the state where each item of a printing job has been set by user operation through the setting screen of the job submitting IF of external apparatus 500 (for example, a PC or a mobile terminal) (that is, the state where the data of various settings related to input images and printing is stored in RAM 104 of image forming apparatus 100) and the “Execute Postprocessing” button (not shown) on the setting screen has been selected.

In Step S10 before execution of the printing job and postprocessing job, control section 101 of image forming apparatus 100 reads the above-described postprocessing profile list stored in storage section 172, and transmits the postprocessing profile list to external apparatus 500 (first user interface section). Through such processing, a list in which profile numbers, profile names, and sheet information (for example, sheet size and basis weight) related to postprocessing are associated with each other is displayed on the display (hereinafter also referred to as display screen) of external apparatus 500 (for example, PC). In Step S10, control section 101 of image forming apparatus 100 may also transmit the postprocessing profile list to postprocessing apparatus 200 and temporarily store it in storage section 242 of postprocessing apparatus 200.

In this embodiment, a list of profile numbers (001 to 035 in this example) as postprocessing job identification numbers, job names (job contents) corresponding to the profile numbers, sheet sizes, processing positions, and the like is displayed on the display of external apparatus 500 (PC or the like) so that the user can designate (select) a profile number from the list. At this time, if the postprocessing profile that the user wants does not exist, the user may display the setting screen of the second user interface section on another external apparatus 500, for example, create a new postprocessing profile (postprocessing job), and then add the created postprocessing job to the existing postprocessing profile list.

In Step S20, control section 101 determines whether or not a postprocessing profile number (any one of 001 to 035 in this example) has been received from external apparatus 500 (for example, PC). Here, when it is determined that no postprocessing profile number has been received from external apparatus 500 (Step S20, NO), control section 101 repeats the determination process of Step S20. In contrast, when it is determined that a postprocessing profile number has been received from external apparatus 500 (Step S20, YES) (see FIG. 2), control section 101 proceeds to Step S30.

In Step S30, control section 101 stores (sets) the postprocessing content (the set content of the postprocessing job) corresponding to the received postprocessing profile number, in RAM 104 in association with the print setting data.

Further, in Step S30, control section 101 transmits (notifies) the postprocessing content (the set content of the postprocessing job) corresponding to the received postprocessing profile number, to control section 201 of postprocessing apparatus 200. If the postprocessing profile list is stored in storage section 242 of postprocessing apparatus 200, control section 101 may transfer the postprocessing profile number, which has been received from external apparatus 500, to postprocessing apparatus 200.

Upon reception of such notification, control section 201 of postprocessing apparatus 200 monitors the statuses of its components, checks whether the postprocessing can be executed, and transmits the check result to control section 101 of image forming apparatus 100. At this time, control section 101 of image forming apparatus 100 may perform image processing, such as shifting or zooming up/down an image (toner image) to be printed on a sheet, as necessary.

In Step S40, control section 101 receives the check result from control section 201 of postprocessing apparatus 200, and determines whether or not postprocessing apparatus 200 can execute the postprocessing job. Here, if control section 101 determines that postprocessing apparatus 200 can execute the postprocessing job (Step S40, YES), the process proceeds to Step S50. In contrast, when control section 101 determines that postprocessing apparatus 200 cannot execute the postprocessing job (Step S40, NO), the process proceeds to Step S60.

In Step S50, control section 101 controls their components to execute a printing job based on the set contents stored (set) in RAM 104, and sends an instruction to postprocessing apparatus 200 to execute postprocessing including cutting processing. Upon completion of the printing job and postprocessing, control section 101 ends the series of processing.

In contrast, in Step S60, control section 101 displays an error message saying that postprocessing cannot be executed, on operation display section 120, and transmits the message to external apparatus 500. In this case, control section 101 ends the process without executing the printing job.

As described above, according to this embodiment, the content of the postprocessing performed by postprocessing apparatus 200 is set through a user IF different from the user IF for making settings for the printing job, so that settings for the image forming process and settings for postprocessing can be made concurrently.

Moreover, according to this embodiment, the content of the postprocessing performed by postprocessing apparatus 200 is registered in a list in advance through a user IF different from the user IF for making settings for the printing job, and designation is made through a number in the list at the time of printing; thus, versatility in making settings for postprocessing and productivity can be enhanced.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a hardware processor that makes settings for an image forming process performed on a sheet, in accordance with an instruction from a user to a first user interface, wherein
the hardware processor makes settings for postprocessing performed on the sheet, on a basis of an instruction from the user to a second user interface that is different from the first user interface, and
the settings for the image forming process and the settings for the postprocessing are made in association with each other.

2. The image forming apparatus according to claim 1, wherein
the settings for the postprocessing include assignment of an identification number, and
upon reception of data containing a printing job with the identification number, the hardware processor makes settings for postprocessing related to the identification number in association with the settings for the image forming process.

3. The image forming apparatus according to claim 1, wherein
the hardware processor generates a postprocessing profile list that is a list of settings for the postprocessing, in accordance with an instruction from the user to the second user interface, and
during making of settings for the image forming process, the hardware processor displays the postprocessing profile list on the first user interface, and when the settings for the postprocessing in the postprocessing profile list are selected, instructs a postprocessing apparatus to follow the selected settings for the postprocessing.

4. The image forming apparatus according to claim 1, wherein the settings for the postprocessing include a setting for cutting the sheet.

5. The image forming apparatus according to claim 1, wherein the second user interface is a web browser.

6. The image forming apparatus according to claim 1, further comprising a storage section that stores the settings for the postprocessing.

7. The image forming apparatus according to claim 1, wherein items of settings displayed on the first user interface and items of settings displayed on the second user interface are different.

8. An image forming system, comprising:
the image forming apparatus according to claim 1; and
a postprocessing apparatus connected on a downstream side of the image forming apparatus.
